(19) United States
(12) Patent Application Publication
(10) Pub. No.: US 2003/0086522 A1
(43) Pub. Date: May 8, 2003

(54) X-ray image storage unit and readout device, and subtraction angiography method employing same

(76) Inventors: Manfred Fuchs, Nuernberg (DE); Erich Hell, Erlangen (DE); Wolfgang Knuepfer, Erlangen (DE); Detlef Mattern, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 10/255,978

(22) Filed: Sep. 26, 2002

(30) Foreign Application Priority Data
Sep. 26, 2001 (DE) 10147420.2

(51) Int. Cl. G21K 1/12

(52) U.S. Cl. 378/19

(57) ABSTRACT

An X-ray image storage unit for storing an X-ray image, particularly for subtraction angiography, has a first storage layer containing a first storage luminophore and a second storage layer containing a second storage luminophore, the first and second storage luminophores being different from one another being applied on opposite sides of a radiation-transparent substrate. In a method for the examination of a patient according to the principle of subtraction angiography, a contrast agent is administered to the patient and the patient is subsequently transirradiated with x-rays. The x-rays penetrating the patient are detected with the two storage layers that respectively contain different storage luminophores. The respective images stored in the storage luminophores are separately read out, either successively or simultaneously, with a readout device designed fro the image storage unit, and are subsequently linearly combined with one another, particularly subtracted.

### BACKGROUND OF THE INVENTION

1. Field of the Invention

The present invention is directed to an X-ray image storage unit for storing an X-ray image, particularly for subtraction angiography, of the type a storage layer that contains a storage luminophore. The invention also is directed to the employment of such an X-ray image storage unit for subtraction angiography as well as to a method for examining a patient according to the principle of subtraction angiography.

2. Description of the Prior Art

U.S. Pat. No. 6,236,058 discloses an image recording system for the purpose of versatile employment for luminescence examinations (in the range of visible light) as well as for examinations with higher-energy beams. This image recording system has a first stimulatable luminophore layer for high-energy rays and a second stimulatable luminophore layer for visible light.

European Application 1 065 523 and German OS 38 20 582 disclose methods and equipment for reading out a radiation image stored in a luminescent screen. Storage films are also disclosed by U.S. Pat. Nos. 5,877,508, 5,880,476 and German PS 40 25 980.

Various image subtraction methods are known in the field of X-ray technology wherein two images are registered under conditions that differ from one another and are subtracted from one another.

A first group of such subtraction methods carries out a kind of “energy subtraction”. The examination subject is multiply exposed to radiation with different energy distributions, and the respectively images resulting therefrom are subtracted in order to resolve structures in this way that would not have been visible given using solely radiation at one energy examination.

This group also includes a version wherein the examination subject only has to be subjected to radiation once, and wherein the radiation—after passing through the examination subject and after registration with a first detector medium—is energy-dependently filtered and is then also acquired by a second detector medium (one-shot energy subtraction). Such methods, for example, are disclosed by U.S. Pat. Nos. 4,526,862 and 5,028,037.

According to U.S. Pat. No. 4,526,862, two intensifier layers that may have materials that are different from one another are provided, with respective photographic films as image storage unit being allocated to these layers. The foremost intensifier layer acts as an energy-dependent filter for the back intensifier layer. Due to the need to distinguish between high-energy information and low-energy information, the readout of the double film pack by means of optical scanning requires the introduction of coding grids into the intensifier layer/film system. This is a disadvantage, as is the fact that the photographic film must be developed first before the readout.

According to U.S. Pat. No. 5,038,037, two storage and stimulatable luminophore layers are present that are separated from one another by an energy-dependent filter, which may be copper-based. The luminophore layers can be directly read out by optical scanning.

The second group of subtraction methods represents quasi “time subtraction methods”. A contrast agent is administered to the examination subject. Images with and without contrast agent are registered and subtracted from one another.

The second group also includes (digital) subtraction angiography. This is an x-ray-diagnostic method with which, for example, vessel images can be displayed isolated. The book by Heinz Morneburg bearing the title “Bildgebende Systeme für die medizinische Diagnostik”, 3rd edition, 1995, Publicis MCD Verlag, pages 350 ff, discloses that two exposures be successively made of the same location with a time interval between the exposures. The patient is injected with a contrast agent. The first exposure, what is referred to as the mask image, is registered without contrast agent in the target area; a second exposure, referred to as the fill image is registered with vessels filled with contrast agent. The two images are subtracted from one another, and congruent image parts of disturbing, high-contrast image details such as, for example, bones or soft parts, are eliminated, so that the blood vessel filled with contrast agent can be separated therefrom, and thus displayed better.

A problem associated with this procedure is that the mask image and the fill image must be registered in a minimum time spacing of a few seconds, because this time is needed for the contrast agent, for example an iodine salt solution to be transported into the vessels in the target region, i.e. in the image field. In this time span, a relative motion of one of the participating components, for example the x-ray tube, the patient or the x-ray detector, leads to an offset of the image details to be subtracted out in the two images, so that disturbing contours and shadows appear in the difference image that are referred as congruency errors. The probability of the occurrence of such artifacts increases with the time difference between the exposure of mask image and fill image. Some of the congruency errors can be entirely or partially compensated by means of an image post-processing technique referred to as a pixel shift. Such a compensation has natural limits since, in particular, the patient is not a rigid object. When the patient, for example, curves slightly or bends in the time span between the mask image and the fill image—which cannot be prevented by even the most complex positioning and support aids or supports distortions arise that are difficult to correct even by processing using software.

### SUMMARY OF THE INVENTION

An object of the present invention is to provide an x-ray image storage unit with which the error susceptibility in an x-ray examination method based on the subtraction of two images, particularly in subtraction angiographies, is reduced. A further object is to provide a method for examining a patient according to the principle of subtraction angiography wherein the error susceptibility is improved.

This object is achieved in accordance with the invention in an x-ray image storage unit is based on the combination of two different storage luminophores. The two storage luminophores, and thus the two storage layers, have different spectral sensitivities, so that the contrast agent in the subtraction angiography, particularly the iodine contrast agent, is differently evaluated. As a result, it is advantageously possible to register the mask image and the fill image with pixel precision and without time delay. Congruency errors thus are precluded to a significant extent. The x-ray image storage unit is particularly employable in digital subtraction x-ray technology, particularly for subtraction angiography.

The two storage layers are preferably rigidly connected to one another or can be rigidly connected to one another. As a result, it is assured that a relative movement between the two storage layers is suppressed, and the image information in the two storage layers can be electronically read out with pixel precision without a software post-correction (pixel shift or the like) being required.

In a preferred embodiment, the two storage layers are applied to opposite sides of a radiation-transparent substrate. Preferably they are vapor-deposited thereat, particularly so as to be, needle-shaped. The application of the two storage layers on a common substrate allows both a distortion-free, pixel-exact registration of the two sub-images and a compact x-ray image storage unit that is easy to handle.

The substrate preferably is made entirely or predominantly of a material having an effective atomic number of less than 30, preferably less than 25 and, in particular less than 20 or less than 15. The material is, in particular, aluminum or carbon. It is thereby assured that the substrate is radiation-transparent to a high degree, i.e. the x-rays are attenuated only slightly when passing onto the side of the substrate facing away from the radiation source.

The substrate preferably is fashioned as a foil. The substrate or the carrier foil comprises, for example, a thickness in the range from 0.05 mm through 0.5 mm, particularly a thickness of 0.2 mm, and thus absorbs optimally little x-radiation.

The x-ray image storage unit of the invention has the capability of storing latent images over a long time. The storage capability of the storage luminophores is achieved by generating energy band gap traps in the luminescent material by suitable doping, for example, by means of the intentional integration of lattice imperfections. Electrons exited by x-rays into the conduction band either fall into the deeper recombination centers, whereby spontaneous emission occurs, or they are captured by the existing traps. Dependent on the type of luminophore employed, these excited traps remain stable over hours or even over weeks. Given excitation with light of a specific wavelength—usually in the red through green spectral range the traps can be read out within a few microseconds. The radiated stimulation light for the readout lifts the electrons collected in the traps back into the conduction band. Some of these electrons are again captured by traps; another part, in contrast, drops into deeper energy levels while emitting emission light. The emission light is detected by a photoelectric receiver and is employed for electronic image generation. The principle of storage foils is also described in the book by Morneburg that has already been cited, page 270 ff.

Dependent on of the transmissivity of the substrate for the radiated stimulation light for the readout, two versions of the inventive storage unit are possible.

In a first version, the substrate is light-impermeable. As a result, the two storage layers can be considered as functioning as two detectors independent of one another that can also be read out completely independently of one another, and thus disturbance-free. To this end, the two storage layers are, for example, charged with light from opposite sides of the substrate, for example light of the same wavelength, without the light coming from the one side being able to proceed onto the opposite storage layer.

In a second version, the substrate is transparent for one light wavelength and opaque for another wavelength, and the substrate preferably is fashioned as an edge filter or band filter. As a result, it is possible to readout the x-ray image store from only one side of the substrate given employment of two different stimulation wavelengths.

Further preferred embodiments are directed to the selection of the storage luminophores.

The first storage luminophore preferably contains a rubidium halogenide, particularly rubidium bromide, rubidium iodide and/or rubidium chloride.

The second storage luminophore preferably contains a cesium halogenide, particularly cesium bromide, cesium iodide and/or cesium chloride.

The storage luminophores—particularly in conjunction with a contrast agent containing iodine—have proven themselves to be particularly suited.

All storage luminophores disclosed in European Application 1 065 523 are suitable for use as storage luminophores in the inventive storage unit.

For enhancing the storability, one of the halogenides or both halogenides is doped, particularly with europium, gallium, thallium and/or with indium.

In a preferred development of the x-ray image storage unit, at least one further storage layer is provided that contains a further storage luminophore that is different from the first storage luminophore and from the second storage luminophore.

The further storage luminophore particularly contains one or more of the aforementioned halogenides, and preferably contains a halogenide of another metal, particularly of strontium or barium.

Given three or more storage layers, it suffices when one substrate functioning as carrier is present overall. The storage layers are either arranged on the substrate on top of another without intermediate layers or spectral filter layers are present between individual storage layers. Such spectral filter layers, for example, can be fashioned as edge filters having an absorption edge in the region of the wavelengths employed for the readout. The filter layers allow a selective readout of the memory layers they separate by means of different stimulation wavelengths.

Especially advantageously, the x-ray image store of the invention is employable in subtraction angiography, wherein a patient is administered a contrast agent, with the two storage luminophores and/or the contrast agent being selected such that the centers of gravity of the spectral sensitivities of the two storage layers lie at different sides of a sensitivity edge of the contrast agent in the region of the applied x-ray spectrum, i.e. in the region of the x-ray tube spectrum. Simulations have shown that contrast intensification essentially occurs by image contrasts without contrast agent being approximately the same in both storage layers and thereby merely disappearing in the difference image.

Preferably, the K-absorption edges of the two storage luminophores lie at different sides with respect to the sensitivity edge of, in particular, an iodine-containing contrast agent.

The above object also is achieved in accordance with the invention in a subtraction angiography method wherein a contrast agent is administered to the patient and subsequently the patient is trans-irradiated with x-rays, the x-rays penetrating the patient being detected with two storage layers that contain different storage luminophores with the sub-images contained in the storage luminophores being separately read out either successively or simultaneously, and wherein the two sub-images are linearly combined, particularly by being subtracted from one another.

Preferably, the detection of the x-rays in the two storage layers is implemented simultaneously or in immediate succession. For example, the detection in the two storage layers is implemented with a time spacing of less than 10 s or 5 S.

Such a procedure advantageously allows a substantially distortion-free irradiation of masked and fill image, virtually in one work step. Congruency errors are suppressed in this way. The aforementioned advantages and developments cited in conjunction with the x-ray image storage unit analogously apply to the method. For example, the two storage layers as in the x-ray image store of the invention are fashioned on a common substrate. The two storage layers, however, also can be fashioned as basically known, individual storage foils that are merely exposed with x-ray in common and isochronically or in immediate succession.

For simultaneous readout, the two storage layers preferably are optically separated from one another, and separate stimulation light is transmitted onto both storage layers and emission light from the two layers excited by the stimulation light is separately detected.

The optical separation of the two storage layers, when these are attached to opposite sides of a radiation-transparent substrate, is established by this common substrate that is then light-impermeable.

Given employment of individual storage foils, these are read out in succession in a scanner, particular with a “flying spot” scanner. Given such a successive readout, it can be necessary, before superimposition of the two sub-images generated by the storage layers to subject the sub-images to a constant pixel shift relative to one another, by software and/or automatically, because an exact pixel-precise readout may not be established under certain circumstances due to adjustment or insertion imprecisions upon introduction of the individual storage foils into, for example, an existing readout device.

A readout device for reading out an x-ray image storage unit having two storage layers with storage luminophores that differ from one has a first scan head for reading out the first storage layer, with a first illumination device for scanning illumination of the first storage layer with stimulation light and a first detector device for detecting the emission light excited by the stimulation light of the first illumination device, and has a second scan head for reading out the second storage layer, with a second illumination device for scanning illumination of the second storage layer with stimulation light and a second detection device for detecting the emission light excited by the stimulation light of the second illumination device.

Such a device allows the simultaneous readout of the two storage layers of the inventive x-ray image store, so that the entire readout event is ended very quickly, particularly in a few seconds.

Especially advantageously, the two scan heads are connected to one another at rigidly fixed positions relative to each other. Due to this relative positional rigidity, the two independent detectors, which represent the two storage layers, can be read out in a pixel-precise manner. This means the registration of the partial images or individual images deriving from the two storage layers is pixel-precise, so that an especially precise overlay of the two sub-images to form an overall image is possible without a correction, for example a software-implemented pixel shift, being absolutely necessary.

Expediently, a scanner device for generating a scan motion of the stimulation light is used for planar scanning of the stored layers.

This preferably has at least one rotating mirror and/or a transport system for moving the image storage unit. For example, the rotating mirror allows a line-by-line scanning to be realized in a first dimension and the transport system allows the scanning in a second dimension to be realized.

The two illumination devices can be a separate lasers or a common laser with a split beam.

The two detector devices can be a separate line detectors, particularly diode or CCD line detectors.

It is particularly expedient in this context when the two illumination devices are separate light-emitting diode lines. In this embodiment, for example, the rotating mirror could be eliminated because the resolution in one dimension is realized by the elongated light-emitting diode line together with the allocated line detector.

In the apparatus of the invention, the wavelength of the stimulation light is preferably such that the substrate of the x-ray image storage unit is opaque for the stimulation light. As a result, the storage layers functioning as two independent detectors can also be read out completely independently of one another, and thus disturbance-free. Separation or selection of readout signals can then be eliminated.

In another preferred embodiment, the x-ray image storage unit can be positioned in the apparatus so that stimulation light from the two illumination devices can be transmitted onto the x-ray image storage unit from opposite directions. A compact structure as well as a fast readout event are achieved as a result.

In another preferred embodiment, the apparatus has an evaluation device that is in communication with the two detector devices and to which the images respectively acquired by the two detector device can be supplied.

The evaluation device preferably allows an overall image that is superimposed pixel-by-pixel, particularly linearly combined or subtracted, to be generated. This overall image, for example, can be displayed at the picture screen.

The initially cited object also can be achieved in accordance with the invention an x-ray image detector for detecting an x-ray image, particularly for subtraction angiography, that has a solid-state image converter, an electronically readable photo-diode matrix on which a scintillator layer containing a scintillator material is applied, and at least one storage layer containing a storage luminophore, whereby the scintillator material and the storage luminophore being different from one another and exhibiting different spectral sensitivities. Such a solid-state image converter is, for example, of a type referred to as a CsI-a:Si-flat detector

The storage layers described in conjunction with the x-ray image storage unit of the invention thus can be replaced by the above-described solid-state image converter. In other words: the solid-state image converter can be considered in the same manner as the disclosed x-ray image store and the disclosed method for examination of a patient according to the principle of the subtraction angiography. For example, the mask image registered by the solid-state image converter and the fill image is registered by the storage layer.

The storage capability in the storage layer is created, for example, by means of an appropriate doping, whereas the storage capability in the solid-state image converter is electronically established.

In addition to the above-described storage luminophore, one or more further storage luminophores can also be present in the converter.

The solid-stage image converter is read out electronically via the photo-diode matrix. A readout device having a scan head can be employed for reading out the storage layer, as described in conjunction with the read out device of the invention.

The embodiments preferred in conjunction with the x-ray image storage unit of the invention and in conjunction with the examination method of the invention and the advantages thereof apply analogously to the inventive x-ray image detector.

### DESCRIPTION OF THE DRAWINGS

FIG. 1 is a sectional view of an x-ray image storage unit of the invention in a first embodiment.

FIG. 2 is a sectional view of an x-ray image store of the invention in a second embodiment.

FIG. 3 is a sectional view of an x-ray image store of the invention in a third embodiment.

FIG. 4 illustrates a first method step (image acquisition) of the method of the invention.

FIG. 5 illustrates a second and third method steps (image readout and image evaluation) of the method of the invention in a first version thereof.

FIG. 6 illustrates second and third method steps (image readout and image evaluation) of the method of the invention in a second version thereof.

FIG. 7 is a first exemplary embodiment of a readout device suitable for the readout of an x-ray image store of the invention.

FIG. 8 is a second exemplary embodiment of a readout device suitable for the readout of an x-ray image store of the invention shown in a plan view.

FIG. 9 shows the readout device of FIG. 8 in a cross-sectional view.

FIG. 10 shows various spectral curves in a schematic and simplified illustration for illustrating the functioning of the different storage layers in the x-ray image storage unit of the invention.

FIG. 11 shows the spectral curve of the mass attenuation coefficient of iodine (as contrast agent) compared to preferably employed storage luminophore.

FIG. 12 is a sum image as result of the method of the invention.

FIG. 13 is a difference image as result of the method according to the invention in the same body region as in FIG. 12.

FIG. 14 shows the quantitative curve of the intensity of the sum image of FIG. 12 given projection of the sum image onto a horizontal axis.

FIG. 15 shows the quantitative curve of the intensity of the difference image of FIG. 13 given projection of the difference image onto a horizontal axis.

FIG. 16 schematically illustrates an x-ray image detector of the invention.

### DESCRIPTION OF THE PREFERRED EMBODIMENTS

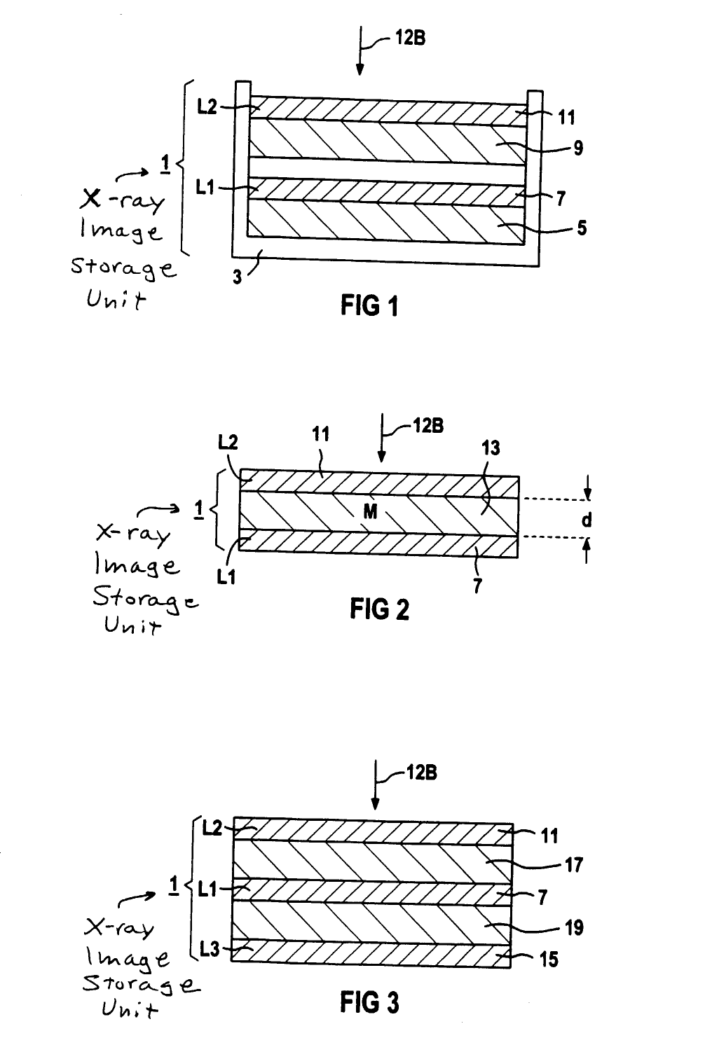

FIG. 1 shows a first embodiment of an x-ray image storage unit 1 of the invention in a sectional view. The x-ray image store 1 has a holding frame 3 into which a first carrier 5 having a first storage layer 7 applied thereon, and a second carrier 9 having a second storage layer 11 applied thereon, can be secured with exact fit. The second carrier 9 can lie directly on the first storage layer 7 or—which is not explicitly shown—spacer devices can be present in order to avoid damage.

The x-ray image storage unit 1 is charged with x-rays 12B that proceed to the first storage layer 7 as well as to the second storage layer 11.

In the second embodiment of an x-ray image storage unit 1 of the invention according to FIG. 2, the two storage layers 7, 11 are vapor-deposited onto opposite sides of one and the same substrate 13. The thickness d of the substrate 13 amounts, for example, to 0.05 mm through 5 mm. For example, the substrate 13 is a flexible foil composed of a material M having an effective atomic number of less than 15, particularly aluminum or carbon.

In each of the two exemplary embodiments of FIGS. 1 and 2, the first storage layer 7 contains europium-doped rubidium bromide as the first storage luminophore L1. The second storage layer 11 contains europium-doped cesium bromide as second storage luminophore L2.

In the third exemplary embodiment of an x-ray image storage unit 1 of the invention shown in FIG. 3, a further storage layer 15 having a further storage luminophore L3 is also present, this differing in chemical composition for the two storage luminophores L1, L2 of the two storage layers 7, 11 and, in particular, also exhibiting a different spectral sensitivity. In the illustrated example, the storage layers 7, 11, 15 are arranged at the end side at or between two substrates 17, 19.

It suffices when one of the substrates 17, 19 is used as a carrier and two of the storage layers are arranged directly above one another. Dependent on the optical properties in the spectral range of the stimulation light, a spectral filter layer can be present between the storage layers arranged above one another, such a spectral filter layer assures that stimulation light of a first wavelength during readout proceeds only into one of the storage layers and stimulation light of a second wavelength proceeds only into the other storage layer.

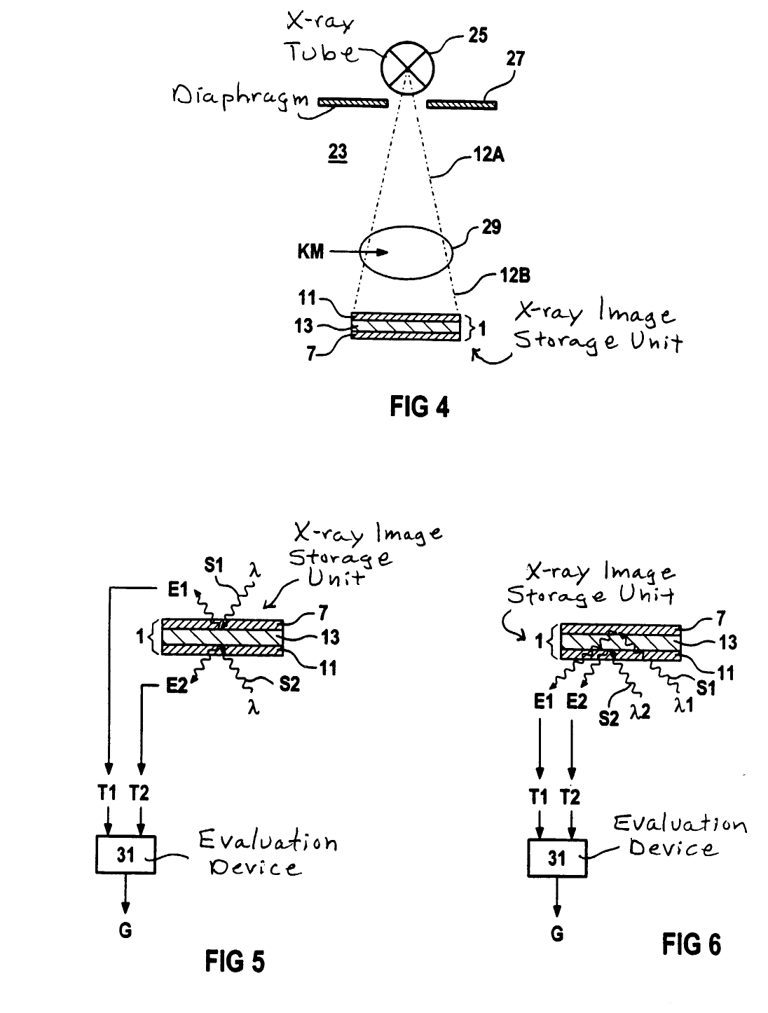

FIG. 4 shows how, in the method of the invention for examining a patient according to the principle of subtraction angiography, x-rays 12A, 12B are simultaneously detected with two storage layers 7, 11 containing different storage luminophores. Before registration of the fill image and the mask image in the two storage layers 7, 11, the patient is injected with a contrast agent KM in the patient's blood vessels. An x-ray apparatus 23 having an x-ray tube 25 emits x-ray beams 12A, 12B adapted by a diaphragm 27. The x-ray beam 12A transirradiates a patient 29 and the imaging contrast that thereby occurs in the transmitted ray beam 12B is simultaneously registered by the two storage layers 7, 11 of the x-ray image store 1.

FIGS. 5 and 6 show two versions wherein the image readout and the image evaluation given the subtraction angiography method of the invention can be implemented digitally. In the first version according to FIG. 5, the substrate 13 is opaque for the stimulation light S1, S2 radiated for the readout of the images T1, T2 stored in the two storage layers 7, 11. The substrate 13 is charged with stimulation light S1 and S2 of the same wavelength A proceeding from both sides. The emission light E1 and E2 caused by the stimulation light beams S1, S2 is separately detected and supplied to a common evaluation device 31 that generates a difference image G as difference between the two sub-images T1, T2.

In the alternative, second version shown in FIG. 6, the substrate 13 is transparent for stimulation light S1 of a first wavelength λ1 and is opaque for stimulation light S2 of a second wavelength λ2. The substrate 13 implemented as an edge filter or band filter is fashioned such that it is also transparent for the emission light El generated by the first stimulation light S1. In this way, it is possible to charge the x-ray image storage unit 1 with light of two different wavelengths λ1, λ2 proceeding from one side and to carry out the detection at the same side. The images T1, T2 acquired from the different emission lights E1, E2 are supplied to an evaluation device 31, analogous to FIG. 5.

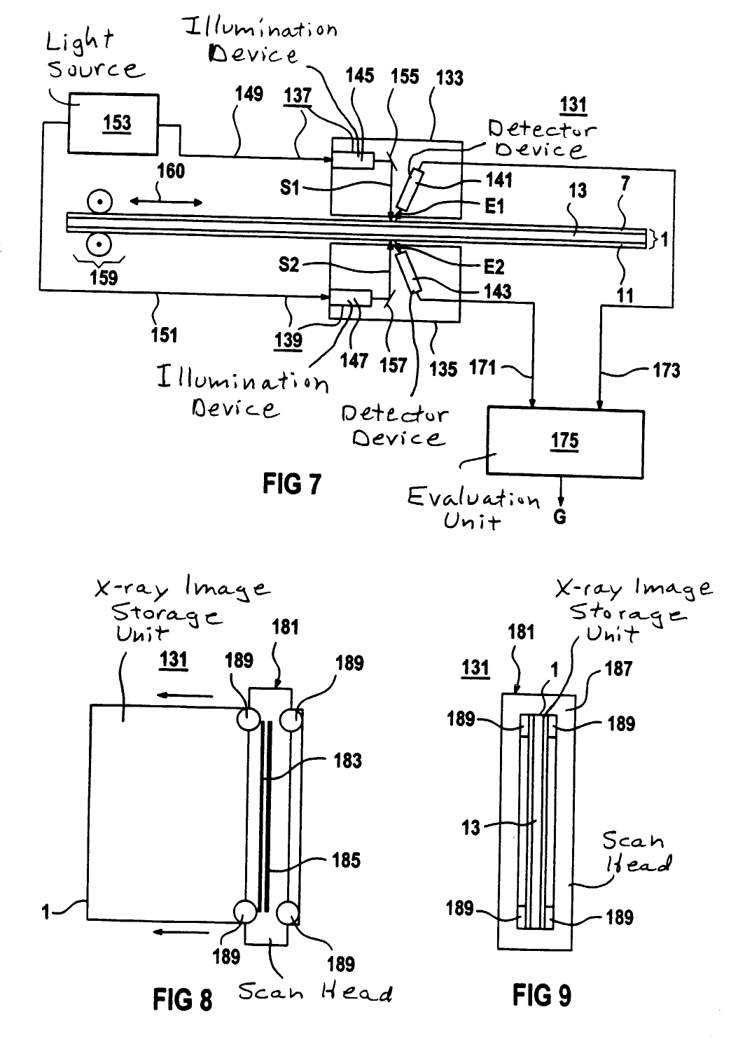

Readout given employment of an x-ray image storage unit 1 (FIG. 1) of the invention can be implemented with a common substrate 13 in detail (second and third step of the x-ray method according to the invention) is shown in detail in FIG. 7. Therein, an apparatus referenced 131 overall is also described for the readout of the radiation image stored in the x-ray image store 1 of the invention. The apparatus 131 has a first scan head 133 for reading out the first storage layer 7 and a second scan head 135 for reading out a second storage layer 11 out. The two scan heads 133, 135 are mechanically rigidly connected to one another (not explicitly shown), so that the two scan heads 133, 135 can also be considered as forming a common scan head. The first scan head 133 has a first illumination device 137 for scanning illumination of the first storage layer 7 with stimulation light S1, and a first detector device 141 for detecting the emission light E1 excited by the stimulation light S1 of the first illumination device 137. The second scan head 135 separately has a second illumination device 139 for scanning illumination of the second storage layer 11 with stimulation light S2, and a second detector device 143 for detecting the emission light E2 excited by the stimulation light S2 of the second illumination device 139. The illumination devices 137, 139 are, for example, separate light transmitters or lasers 145 and 147 that are electrically supplied from a source 153 via cables 149 and 151. Alternatively, a common light source or a common laser could also be provided at 153, the light thereof being supplied to the scan heads 133 and 135 via the respective cables 149, 159 that are then implemented as optical fibers. The lasers emit visible light.

In the illustrated example, the stimulation light S1 and S2 is respectively scanned line-by-line over the first storage layer 7 and the second storage layer 11 by a separate, rotating mirrors 155 and 157. Alternatively, the line-by-line scanning can be realized with only a single rotating mirror and with a beam splitter following thereupon.

For scanning the storage layers 7, 11 along a second axis (“column”), the stimulation light S1, S2 either can be scanned along a second axis with the rotating mirrors 155, 157 or—as shown—a transport system 159 for moving the image store 1 with the scan head can be used. The transport system 159 has two rollers that drive the image storage unit 1. As an alternative, the image storage unit 1 could be at rest and the scan head could be moved by a drive unit (not shown) along the double arrow 160.

The detector devices 141, 143 are only schematically indicated. For example, they each can have a micro-lens for collecting the emission light E1, E2 and/or an optical fiber. The detector emission light E1, E2 or corresponding electrical signals are supplied via lines 171, 173 to an evaluation device 175 that generates a linearly combined image, preferably a difference image G, from the two individual images of the respective storage layers 7 and 11.

FIG. 8 (plan view) and FIG. 9 (section) show a further exemplary embodiment of a readout device 131. In this exemplary embodiment, the scan head 181 is equipped with two separate light-emitting diode lines, one of which is provided for the first storage layer 7 and the other of which is provided for the second storage layer 11. Only the upwardly residing light-emitting diode line 183 is visible in FIG. 8. In an analogous way, the scan head 181 has a line detector for each of the two storage layers 7, 11, with only the upwardly residing line detector 185 being possible in FIG. 8. Using the light-emitting diode line 183, stimulation light is emitted onto one of the two storage layers 7 or 11 over the entire width of the image storage unit 1, and the emission light excited as a result is detected by the neighboring line detector 185. The image storage unit 1 can be read out, for example, in about five seconds with such a scan head 181. The registration of the two individual images is likewise pixel-precise, since both the detectors as well as the two line detectors realized as CCD readout lines are mechanically rigidly connected.

A housing 187 of the scan head 181 surrounds the image storage unit 1. Four guide elements 189 guides the image storage unit 1. The output signals of the line detectors given the exemplary embodiment of FIGS. 8 and 9 are supplied to an evaluation device, analogous to FIG. 7.

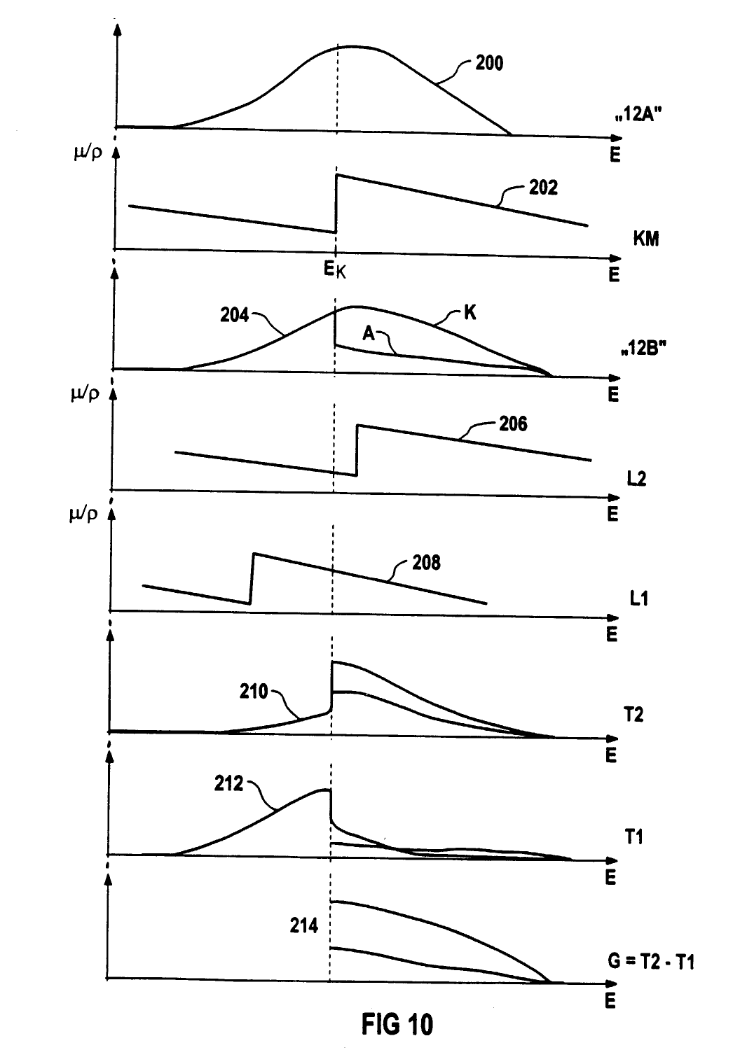

For a better understanding of the functioning of the x-ray image storage unit of the invention, FIG. 10 shows various spectral curves in a highly simplified form. The x-ray quantum energy E is entered on the horizontal axis. The respective vertical axes are not uniformly scaled.

The x-ray tube spectrum 200 (“intensity”) would be measurable, for example, in the x-ray beam 12A preceding the patient 29 (see FIG. 4). Shown below this as curve 202 is the mass attenuation coefficient μ/r of the contrast agent KM. The K-absorption edge of the contrast agent KM is referenced EK.

The x-ray spectrum 204 (“intensity”) following the patient 29 in the x-ray beam 12B differs spatially (see FIG. 4). The intensity is lower in the region of arteries A containing contrast agent than it is in regions next to these, in bones K free of contrast agent.

Curve 206 schematically shows the sensitivity or the mass attenuation coefficient μ/r of the second storage luminophore L2 and curve 208 schematically shows the sensitivity or the mass attenuation coefficient μ/r of the first storage luminophore L1.

The curve 210 shows the spectral course in the detector signal of the second storage luminophore L2 and, analogously, the curve 212 shows the spectral course in the detector signal of the first storage luminophore L1. The differences for two different locations, with and without contrast agent, are indicated in the spectral curves 210, 212. The images T2 and T1 derive from the location-dependency of the spectra that are summed-up or integrated at every location over the spectral axis.

Curve 210 is the spectral curve in a difference image. The spectrum of a difference image B is likewise shown for the evaluation device 31, 175. It can be seen from the schematic considerations that have been presented, that the two different storage luminophores L1, L2 should have their principal sensitivity respectively above and below the K-edge of the contrast agent KM that is employed.

In the x-ray image storage unit 1 according to the invention, contrast intensification essentially occurs by image contrasts without contrast agent being of approximately the same size in both storage layers 7, 11 and therefore the nearly disappear in the difference 214. As a result, an effective isolation of iodine-containing vessels is achieved in the difference image in digital subtraction angiography (DSA).

Also achieved as a further advantage in a sum image is a higher detection efficiency given low tube voltages compared to the employment of only one storage foil.

The two storage layers 7, 11 can be optimized by having differing layer thicknesses, so that bone contrast can be minimized further in the difference image.

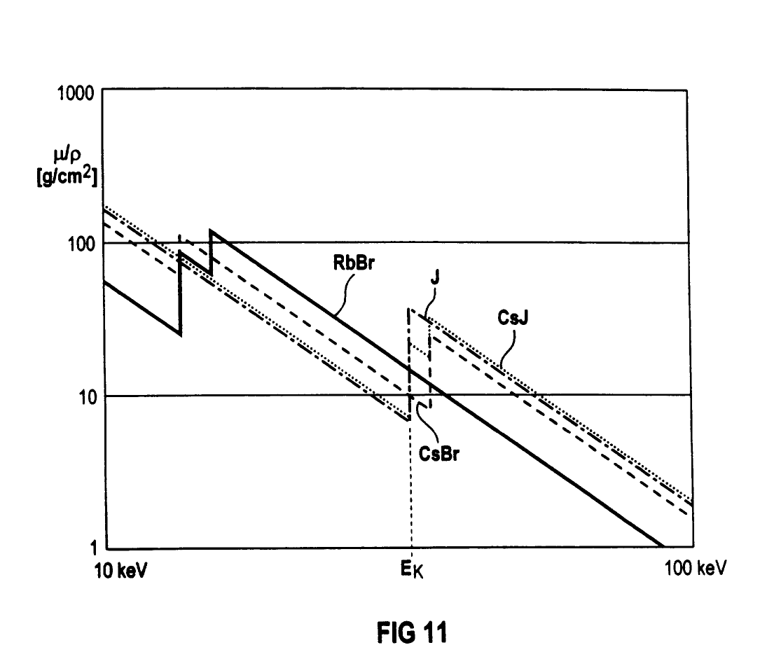

FIG. 11 shows the mass attenuation coefficient p/r quantitatively for different storage luminophores and for iodine I as contrast agent KM in the range of an x-ray quantum energy E between 10 keV and 100 keV. The mass attenuation coefficient μ/r is logarithmically entered on the vertical axis. I references the curve for iodine. CsI references the curve for cesium iodide, RbBr references the curve for rubidium bromide and CsBr references the curve for cesium bromide. The K-edge of the preferred rubidium bromide RbBr lies at an energy below the K-edge Ek of iodine 1. In contrast thereto, pronounced absorption edges of cesium iodide CsI or of cesium bromide CsBr lie in the proximity of or above the K-edge Ek of iodine 1.

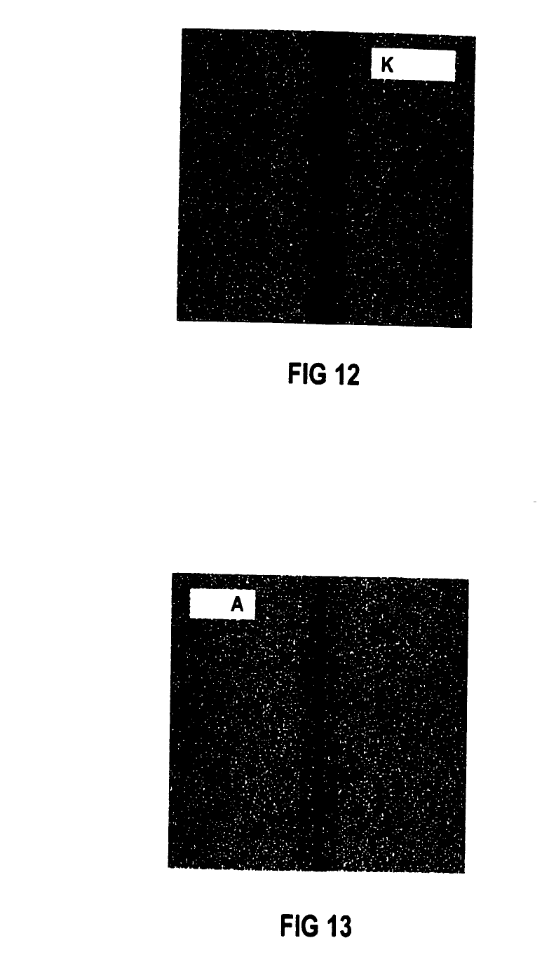

FIG. 12 shows a simulation of a sum image as would derive given the addition of the two images T1, T2 of the two storage layers 7, 11. This sum image is largely identical to an image registered with a single-layer storage foil (having the same total thickness). However, the detection efficiency given unchanging image sharpness is improved in the sum image.

FIG. 13 shows a difference image having significantly reduced contrast for bones K (see FIG. 12), so that an artery A is clearly emphasized.

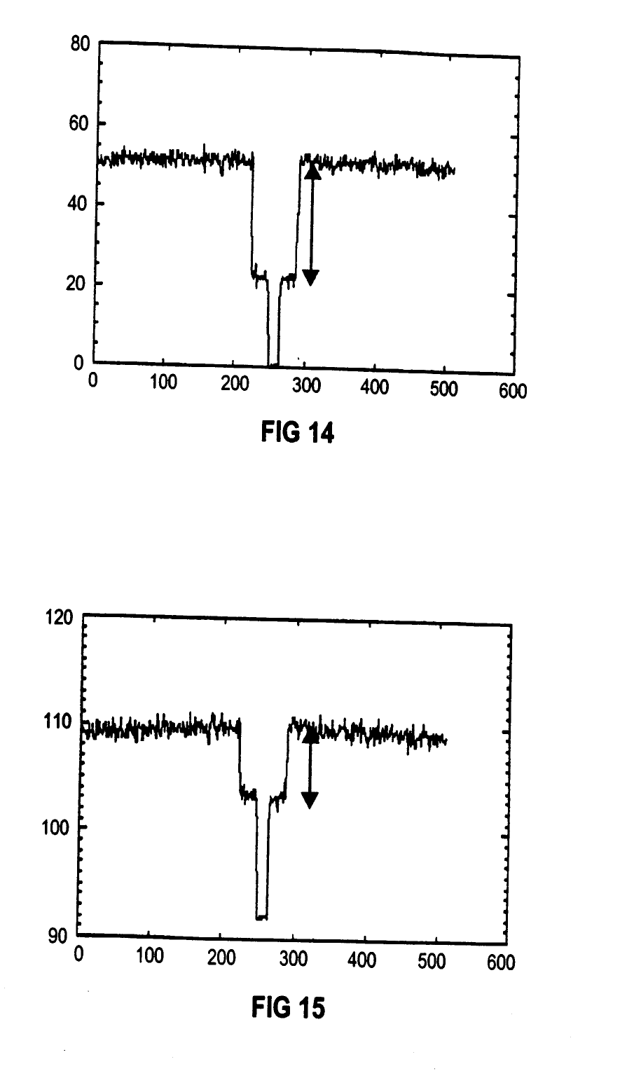

In FIGS. 14 and 15, the projections of the sum image according to FIG. 12 and the difference image according to FIG. 13 are respectively shown on a horizontal location axis. As indicated by the shortening of the double arrow entered therein, the contrast of the bone K that is disturbing for the presentation of the artery A is clearly reduced in FIG. 15.

The x-ray voltage in the exemplary embodiments of FIGS. 12 through 15 amounts to 55 kV. An iodine solution of 370 milligrams sodium iodide (NaI) in 1 ml water is assumed as the contrast agent.

The x-ray image storage unit 1 of the invention can be advantageously combined with an x-ray solid-state image converter, for example with what is referred to as a CsI a-SI flat detector. Such a solid-state image converter is disclosed, for example, by German OS 43 21 789. It has light-sensitive cells arranged in a matrix, each all having two oppositely circuited diodes, of which at least one is a photodiode. Moreover, driver circuits are present for driving the diodes with control pulses, the diodes being connected between the respective row and column lines of the drive circuits. For example, an x-ray image storage unit 1 of the invention and a solid-state image converter can be combined with one another to form unitary structural component. Due to the greater distance between the two storage layers 7, 11 caused by the housing of the flat detector, a different imaging scale would exist in the two sub-images T1, T2, however, this can be corrected with software.

In this described combination of the x-ray image storage unit 1 of the invention with a solid-state image converter, a total of three different storage layers would be present, namely the two storage layers 7, 11 having respective a storage luminophores as well as the flat detector that likewise performs a storage function, although electronically. In the basic version of such a combination, only a single storage layer is present. The storage luminophore in the storage layer is then different from a scintillator material (CsI) in the solid-state image converter and has a spectral sensitivity that is also different therefrom.

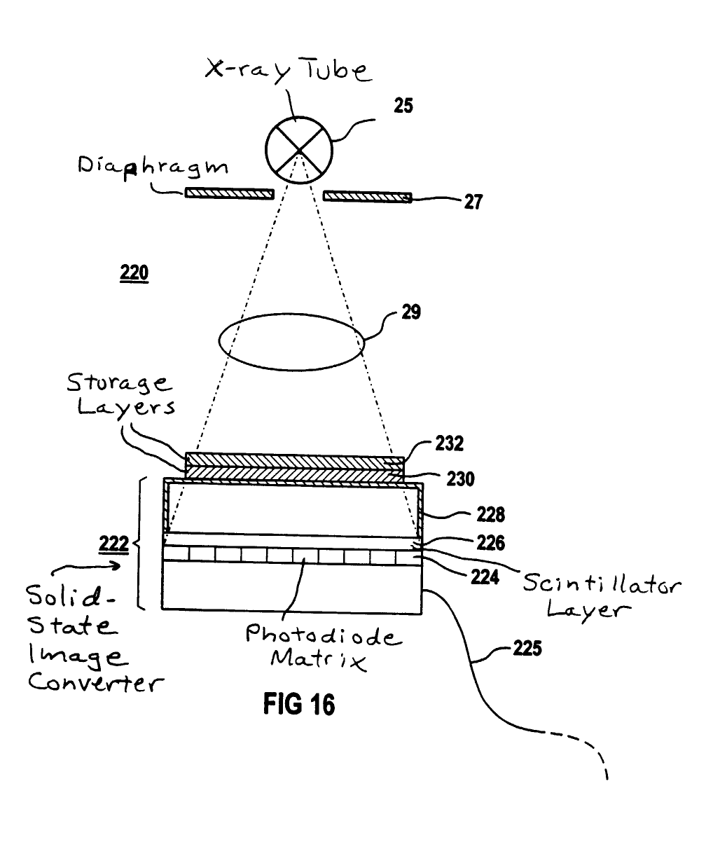

An example of a combination of a solid-state image converter with a storage layer is shown in FIG. 16. This shows an x-ray image detector 220 that has a solid-state image converter 222. The image converter 222 has a photo-diode matrix 224 that can be read out via line 225 and over which a scintillator layer 226 is applied, the scintillator layer 226 containing cesium iodide and converting the incident x-radiation into light. The photodiode matrix 224 is composed of hydrogenated amorphous silicon (aSI:H). The individual light-sensitive cells of the matrix 224 can be respectively read out via electronic circuits. At the input side with reference to incoming x-rays, a storage layer 230 is arranged in a housing 228 and is firmly joined to the housing 228. A storage layer 230 contains, for example, rubidium bromide (RbBr) as a storage luminophore. This storage layer 230 can be read out via a scanner.

A further storage layer 232 is applied over the storage layer 230, the further storage layer 232 having a further storage luminophore that is different from the storage luminophore in the storage layer 230 and from the scintillator material in the scintillator layer 226. Examinations based on contrast agent are possible in an especially efficient way with these three different spectral sensitivities.

Although modifications and changes may be suggested by those skilled in the art, it is the intention of the inventors to embody within the patent warranted hereon all changes and modifications as reasonably and properly come within the scope of their contribution to the art.

We claim as our invention:

1. An x-ray image storage unit for storing x-ray images, comprising:
a first storage layer containing a first storage luminophore for storing a first x-ray image; and
a second storage layer containing a second storage luminophore, different from said first storage luminophore, for storing a second x-ray image.

2. An x-ray image storage unit as claimed in claim 1 wherein said first and second storage layers are rigidly connected to each other.

3. An x-ray image storage unit as claimed in claim 1 wherein said first and second storage layers are rigidly connectable to each other.

4. An x-ray image storage unit as claimed in claim 1 further comprising a radiation-transparent substrate having opposite sides, and wherein said first and second storage layers are applied respectively onto said opposite sides of said substrate.

5. An x-ray image storage unit as claimed in claim 4 wherein said first and second storage layers are vapor-deposited respectively onto said opposite sides of said substrate.

6. An x-ray image storage unit as claimed in claim 4 wherein said substrate is substantially entirely comprised of a material selected from the group consisting of material having an effective atomic number of less than 30, material having an effective atomic number of less than 25, material having an effective atomic number of less than 20, material having an effective atomic number of less than 15, aluminum, and carbon.

7. An x-ray image storage unit as claimed in claim 4 wherein said substrate comprises a foil.

8. An x-ray image storage unit as claimed in claim 4 wherein said substrate is impermeable to light.

9. An x-ray image storage unit as claimed in claim 4 wherein said substrate is transparent to light at a first wavelength and opaque to light of a second wavelength, so that said substrate functions as a filter selected from the group consisting of edge filters and band filters.

10. An x-ray image storage unit as claimed in claim 1 wherein said first luminophore contains a rubidium halogenide.

11. An x-ray image storage unit as claimed in claim 10 wherein said rubidium halogenide is at least one rubidium halogenide selected from the group consisting of rubidium bromide, rubidium iodide and rubidium chloride.

12. An x-ray image storage unit as claimed in claim 10 wherein said rubidium halogenide is doped with at least one element selected from the group consisting of europium, gallium, thallium and indium.

13. An x-ray image storage unit as claimed in claim 1 wherein said second luminophore is a cesium halogenide.

14. An x-ray image storage unit as claimed in claim 13 wherein said cesium halogenide is at least one halogenide selected from the group consisting of cesium bromide, cesium iodide and cesium chloride.

15. An x-ray image storage unit as claimed in claim 13 wherein said cesium halogenide is doped with at least one element selected from the group consisting of europium, gallium, thallium and indium.

16. An x-ray image storage unit as claimed in claim 1 further comprising:
a third storage layer containing a third storage luminophore that is different from said first storage luminophore and different from said second storage luminophore.

17. An x-ray image storage unit as claimed in claim 1 for use in subtraction angiography wherein a contrast agent is administered to a patient and wherein said patient is exposed to x-rays having an applied x-ray spectrum associated therewith, and wherein each of said first and second storage luminophores has a spectral sensitivity in said applied x-ray spectrum having a center of gravity, and wherein the respective centers of gravity of said first and second storage luminophores are on opposite sides of a sensitivity edge of said contrast agent in said applied x-ray spectrum.

18. An x-ray image storage unit as claimed in claim 17 wherein said first and second storage luminophores have respective K-absorption edges in said applied x-ray spectrum, and wherein the respective K-absorption edges of said first and second storage luminophores are disposed at opposite sides of said sensitivity edge of said contrast agent in said applied x-ray spectrum.

19. A method for conducting a subtraction angiography examination of a patient, comprising the steps of:
administering a contrast agent to a patient;
after administration of said contrast agent, irradiating said patient with x-rays;
detecting x-rays penetrating said patient with said contrast agent therein with a first x-ray image storage layer containing a first storage luminophore and storing a first image of said patient in said first storage layer, and with a second storage layer containing a second storage luminophore, different from said first storage luminophore, and storing a second image of said patient in said second storage layer;
reading out said first image and said second image; and
linearly combining said first image and said second image to obtain an overall image of said patient.

20. A method as claimed in claim 19 wherein the step of reading out said first and second images comprises reading out said first and second images in succession.

21. A method as claimed in claim 19 wherein the step of reading out said first and second images comprises reading out said first and second images simultaneously.

22. A method as claimed in claim 19 wherein the step of linearly combining said first and second images comprises subtracting one of said first and second images from the other of said first and second images.

23. A method as claimed in claim 19 comprising the additional steps of:
optically separating said first and second storage layers from each other;
simultaneously and separately transmitting stimulation light onto each of said first and second storage layers, thereby causing each of said first and second storage layers to emit emission light, excited by said stimulation light, dependent on the respective first and second images stored in said first and second storage layers; and
separately detecting the respective emission light emitted by said first and second storage layers.

24. A method as claimed in claim 19 wherein the step of irradiating said patient with x-rays comprises irradiating said patient with x-rays having an applied x-ray spectrum associated therewith, and wherein each of said first and second storage luminophores has a spectral sensitivity with a center of gravity in said applied x-ray spectrum, and wherein said contrast agent has a sensitivity edge in said applied x-ray spectrum, and comprising the additional step of:
selecting said first and second storage luminophores so that the respective centers of gravity of said first and second storage luminophores in said applied x-ray spectrum are at opposite sides of said sensitivity edge of said contrast agent in said applied x-ray spectrum.

25. A method as claimed in claim 19 wherein the step of irradiating said patient with x-rays comprises irradiating said patient with x-rays having an applied x-ray spectrum associated therewith, and wherein each of said first and second storage luminophores has a spectral sensitivity with a center of gravity in said applied x-ray spectrum, and wherein said contrast agent has a sensitivity edge in said applied x-ray spectrum, and comprising the additional step of:
selecting said contrast agent so that the respective centers of gravity of said first and second storage luminophores in said applied x-ray spectrum are at opposite sides of said sensitivity edge of said contrast agent in said applied x-ray spectrum.

26. An x-ray image detector comprising:
a solid-state image converter comprising an electronically readable photodiode matrix having a scintillator layer, containing a scintillator substance, applied thereto; and
at least one storage layer containing a storage luminophore, said scintillator substance and said storage luminophore being different from each other and exhibiting respectively different spectral sensitivities.
